(19) United States
(12) Patent Application Publication
(10) Pub. No.: US 2024/0013501 A1
(43) Pub. Date: Jan. 11, 2024

(54) MOTION SICKNESS REGULATION DEVICE, MOTION SICKNESS REGULATION METHOD, AND STORAGE MEDIUM STORING MOTION SICKNESS REGULATION PROGRAM

(71) Applicant: Mitsubishi Electric Corporation, Tokyo (JP)

(72) Inventors: Kotoyu SASAYAMA, Tokyo (JP); Atsushi HORI, Tokyo (JP)

(73) Assignee: Mitsubishi Electric Corporation, Tokyo (JP)

(21) Appl. No.: 18/371,734

(22) Filed: Sep. 22, 2023

Related U.S. Application Data
(63) Continuation of application No. PCT/JP2021/015038, filed on Apr. 9, 2021.

(51) Int. Cl. G06T 19/20; G06T 7/70; G06T 15/50

(52) U.S. Cl. CPC G06T 19/20; G06T 7/70; G06T 15/50; G06T 2219/2004; G06T 2219/2012

(57) ABSTRACT

A motion sickness regulation device includes processing circuitry to generate stimulus information to be used for displaying a motion sickness regulation image for regulating a level of motion sickness occurring to a user viewing a gaze region, as a region in which real scenery is visible or a region in which a gaze image as an image including a gaze target is displayed, based on movement of the scenery or the gaze image in the gaze region; and to generate the motion sickness regulation image based on the stimulus information, to specify a motion sickness regulation region as a region as part or a whole of a region excluding the gaze region, and to have the motion sickness regulation image displayed in the motion sickness regulation region.

### CROSS-REFERENCE TO RELATED APPLICATION

This application is a continuation application of International Application No. PCT/JP2021/015038 having an international filing date of Apr. 9, 2021.

### BACKGROUND OF THE INVENTION

### 1. Field of the Invention

The present disclosure relates to a motion sickness regulation device, a motion sickness regulation method and a motion sickness regulation program.

### 2. Description of the Related Art

There has been proposed an information processing device that displays a stationary object in a user's field of view so as to prevent the user wearing an HMD (Head-Mounted Display) from feeling the illusion that the user is swaying (i.e., so as to make the user recognize that the user is not swaying) (see Patent Reference 1, for example).

Patent Reference 1: WO 2019/225354 (see paragraphs 0070 to 0075 and FIG. 7 to FIG. 9, for example).

However, with the above-described information processing device, it is difficult to appropriately regulate the motion sickness (e.g., vehicle motion sickness and video motion sickness) occurring to the user viewing a real moving gaze target or a moving gaze target in an image.

### SUMMARY OF THE INVENTION

An object of the present disclosure is to provide a motion sickness regulation device, a motion sickness regulation method and a motion sickness regulation program that make it possible to appropriately regulate the motion sickness of the user.

A motion sickness regulation device in the present disclosure includes processing circuitry to generate stimulus information to be used for displaying a motion sickness regulation image for regulating a level of motion sickness occurring to a user viewing a gaze region, as a region in which real scenery is visible or a region in which a gaze image as an image including a gaze target is displayed, based on movement of the scenery or the gaze image in the gaze region; and to generate the motion sickness regulation image based on the stimulus information, to specify a motion sickness regulation region as a region as part or a whole of a region excluding the gaze region, and to have the motion sickness regulation image displayed in the motion sickness regulation region.

A motion sickness regulation method in the present disclosure is a method executed by a motion sickness regulation device, including: generating stimulus information to be used for displaying a motion sickness regulation image for regulating a level of motion sickness occurring to a user viewing a gaze region, as a region in which real scenery is visible or a region in which a gaze image as an image including a gaze target is displayed, based on movement of the scenery or the gaze image in the gaze region; and generating the motion sickness regulation image based on the stimulus information, specifying a motion sickness regulation region as a region as part or a whole of a region excluding the gaze region, and having the motion sickness regulation image displayed in the motion sickness regulation region.

According to the present disclosure, the motion sickness of the user can be regulated appropriately.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing a configuration of a motion sickness regulation device according to a first embodiment and an example of an image displayed on a display;

FIG. 2 is a diagram showing an example of a hardware configuration of the motion sickness regulation device according to the first embodiment;

FIG. 3 is a diagram for explaining movement of an image (including a gaze image and a motion sickness regulation image) displayed on the display shown in FIG. 1;

FIG. 4 is a diagram showing an example of movement of an image displayed on the display shown in FIG. 1 and the direction of a self-kinesthetic sensation;

FIG. 5 is a flowchart showing an operation of the motion sickness regulation device according to the first embodiment;

FIGS. 6A to 6C are diagrams showing a first example of a mode of emergence of the motion sickness regulation image (i.e., an example of gradually changing transmittance of the motion sickness regulation image);

FIGS. 7A to 7C are diagrams showing a second example of the mode of emergence of the motion sickness regulation image (i.e., an example of gradually changing the size of a gaze region);

FIGS. 8A and 8B are diagrams showing a third example of the mode of emergence of the motion sickness regulation image (i.e., an example of gradually changing the motion sickness regulation image from a gray image to a stripe pattern image);

FIGS. 9A and 9B are diagrams showing a fourth example of the mode of emergence of the motion sickness regulation image (i.e., an example of gradually increasing the moving speed of the motion sickness regulation image from a stationary state);

FIGS. 10A and 10B are diagrams showing a fifth example of the mode of emergence of the motion sickness regulation image (i.e., an example of gradually increasing the blurring of the motion sickness regulation image from a clear state);

FIGS. 11A to 11C are diagrams showing another example of the image displayed on the display (an example in which a gaze region is in a quadrangular shape);

FIGS. 12A and 12B are diagrams showing other examples of objects (waterdrops and butterflies) forming the motion sickness regulation image;

FIG. 13 is a diagram showing a configuration of a motion sickness regulation device according to a second embodiment and an example of real scenery viewed through a windshield of a vehicle and a motion sickness regulation image displayed on the windshield;

FIG. 14 is a diagram showing an example of a hardware configuration of the motion sickness regulation device according to the second embodiment;

FIG. 15 is a diagram for explaining movement of the real scenery viewed through the windshield shown in FIG. 13 and movement of the motion sickness regulation image displayed on the windshield;

FIGS. 16A and 16B are diagrams showing an example of the movement of the real scenery viewed through the windshield shown in FIG. 13 and the movement of the motion sickness regulation image displayed on the windshield (when the vehicle is traveling forward);

FIGS. 17A and 12B are diagrams showing another example of the movement of the real scenery viewed through the windshield shown in FIG. 13 and the movement of the motion sickness regulation image displayed on the windshield (when the vehicle turns left);

FIG. 18 is a diagram showing a configuration of a motion sickness regulation device according to a third embodiment;

FIG. 19 is a flowchart showing an operation of the motion sickness regulation device according to the third embodiment; and

FIGS. 20A to 20C are diagrams showing an example of an image displayed on a display connected to the motion sickness regulation device according to the third embodiment.

### DETAILED DESCRIPTION OF THE INVENTION

A motion sickness regulation device, a motion sickness regulation method and a motion sickness regulation program according to each embodiment will be described below with reference to the drawings. The following embodiments are just examples and it is possible to appropriately combine embodiments and appropriately modify each embodiment. Throughout the drawings, components identical or similar to each other are assigned the same reference character.

### First Embodiment

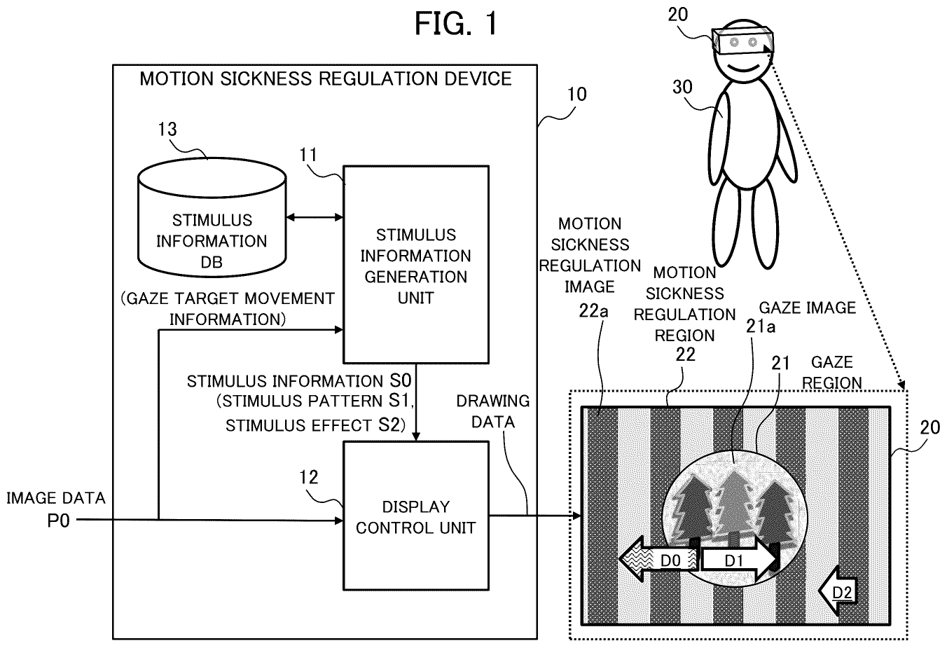

FIG. 1 is a diagram showing a configuration of a motion sickness regulation device 10 according to a first embodiment and an example of an image displayed on a display 20. The motion sickness regulation device 10 is a device capable of executing a motion sickness regulation method according to the first embodiment. The motion sickness regulation device 10 is a computer, for example. The motion sickness regulation device 10 is capable of executing the motion sickness regulation method according to the first embodiment by executing a motion sickness regulation program. The display 20 as a display unit that displays an image is, for example, an HMD, a television, a liquid crystal monitor, a screen onto which an image is projected by a projector, or the like.

As shown in FIG. 1, the motion sickness regulation device 10 includes a stimulus information generation unit 11, a display control unit 12, and a stimulus information database (stimulus information DB) 13 previously stored in a storage device. The stimulus information DB 13 does not need to be stored in a storage device as a part of the motion sickness regulation device 10 but can be stored in an external storage device capable of communicating with the motion sickness regulation device 10.

The stimulus information generation unit 11 generates stimulus information S0, to be used for making the display 20 display a motion sickness regulation image (i.e., stimulus image) 22a regulating the level of the motion sickness occurring to a user 30 viewing a gaze region 21, based on movement of a gaze target in the gaze region 21 as a region in which a gaze image 21a as an image including the gaze target is displayed. For example, the stimulus information generation unit 11 receives image data P0 as a source of the gaze image 21a and generates the stimulus information S0 by reading out a stimulus pattern S1, a stimulus effect S2, or both of the stimulus pattern S1 and the stimulus effect S2 from the stimulus information DB 13 based on the image data P0. The stimulus pattern S1 includes information regarding shapes, sizes, the number, arrangement, etc. of displayed objects, for example. The stimulus effect S2 includes one or more of display conditions such as a moving speed, a size, a shape, a blurring level, luminance, chromaticity and saturation of the motion sickness regulation image 22a to be displayed. Further, the stimulus effect S2 can include a method of changing the display conditions.

The display control unit 12 generates the motion sickness regulation image 22a based on the stimulus information 30, specifies a motion sickness regulation region 22 as a region as part or the whole of a region on the display 20 excluding the gaze region 21, and has the motion sickness regulation image 22a displayed in the motion sickness regulation region 22. While the motion sickness regulation region 22 is a region adjoining the gaze region 21, for example, the motion sickness regulation effect can be exhibited even when the motion sickness regulation region 22 is not adjoining the gaze region 21 (e.g., when the motion sickness regulation region 22 and the gaze region 21 are arranged with spacing between them). In FIG. 1, the gaze image 21a includes scenery such as trees, and moves in a moving direction D1. A direction D0 of a self-kinesthetic sensation (vection) at that time is a direction opposite to the moving direction D1. Therefore, when the movement of the gaze image 21a in the moving direction D1 causes the user 30 to be motion sickness, the level of the motion sickness of the user 30 can be reduced by moving the motion sickness regulation image 22a including the stimulus pattern in a moving direction D2 that is the same as the direction D0 of the vection. Further, while the direction D0 of the vection and the moving direction D2 of the motion sickness regulation image 22a do not necessarily have to coincide with each other, it is desirable to make the directions coincide with each other.

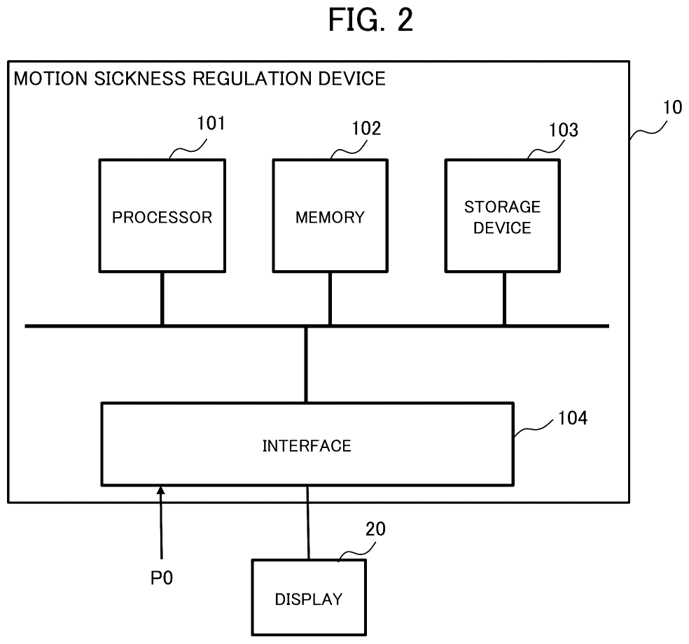

FIG. 2 is a diagram showing an example of a hardware configuration of the motion sickness regulation device 10 according to the first embodiment. As shown in FIG. 2, the motion sickness regulation device 10 includes a processor 101 such as a CPU (Central Processing Unit), a memory 102 as a volatile storage device, and a nonvolatile storage device 103 such as a hard disk drive (HDD) or a solid state drive (SSD). The memory 102 is a volatile semiconductor memory such as a RAM (Random Access Memory), for example. The motion sickness regulation device 10 includes an interface 104.

Functions of the motion sickness regulation device 10 are implemented by processing circuitry. The processing circuitry can be either dedicated hardware or the processor 101 executing a program stored in the memory 102. The processor 101 can be any one of a processing device, an arithmetic device, a microprocessor, a microcomputer and a DSP (Digital Signal Processor).

In the case where the processing circuitry is dedicated hardware, the processing circuitry is, for example, a single circuit, a combined circuit, a programmed processor, a parallelly programmed processor, an ASIC (Application Specific Integrated Circuit), an FPGA (Field-Programmable Gate Array) or a combination of some of these circuits.

In the case where the processing circuitry is the processor 101, the motion sickness regulation program is implemented by software, firmware, or a combination of software and firmware. The software and the firmware are described as programs and stored in the memory 102. The storage device may be a non-transitory computer-readable storage medium (i.e., a record medium) storing a program such as the motion sickness regulation program. The processor 101 implements the functions of the units shown in FIG. 1 by reading out and executing the motion sickness regulation program stored in the memory 102.

It is also possible to implement part of the motion sickness regulation device 10 by dedicated hardware and part of the motion sickness regulation device 10 by software or firmware. As above, the processing circuitry is capable of implementing the above-described functions by hardware, software, firmware or a combination of some of these means.

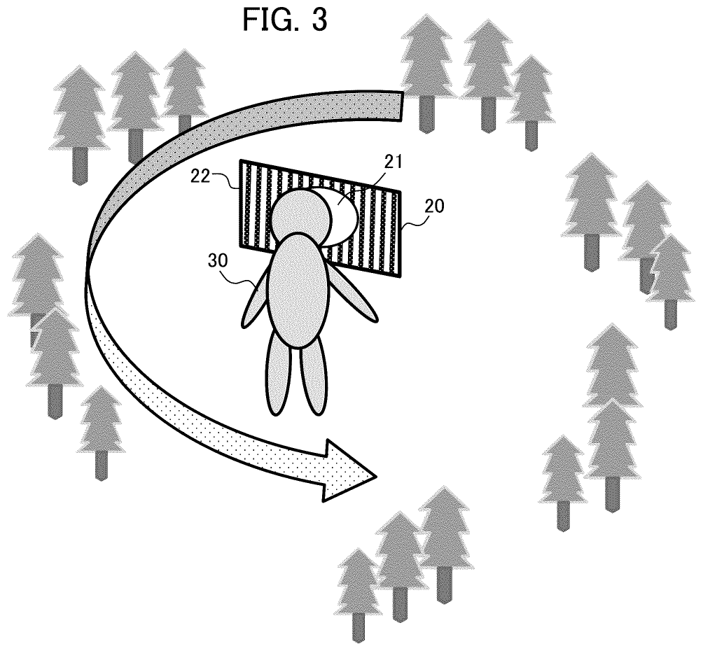

FIG. 3 is a diagram for explaining the movement of an image (including the gaze image 21a and the motion sickness regulation image 22a) displayed on the display 20 shown in FIG. 1. The gaze image 21a displayed on the display 20 shown in FIG. 1 corresponds to scenery when the user 30 wearing a display having an opening at its center in front of the user 30's face has changed the direction of the user 30's body counterclockwise at the same position as shown in FIG. 3. The direction D0 of the vection in this case is the direction opposite to the moving direction D1 of the scenery.

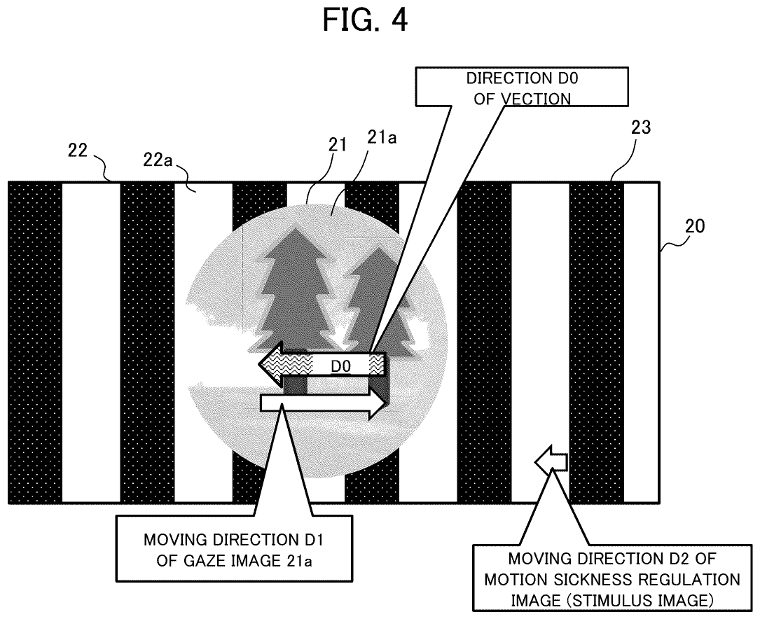

FIG. 4 is a diagram showing an example of movement of the image displayed on the display 20 shown in FIG. 1. The image displayed on the display 20 shown in FIG. 4 includes the gaze image 21a displayed in the gaze region 21 in the vicinity of the center and the motion sickness regulation image 22a displayed in the motion sickness regulation region 22 arranged around the gaze region 21 to adjoin the gaze region 21. The gaze image 21a is an image based on the inputted image data P0. The motion sickness regulation image 22a is a stimulus image generated based on the stimulus information S0. As shown in FIG. 4, the user 30 is feeling (i.e., illuded) that the user 30 is moving in the direction D0, and thus the level of the motion sickness of the user 30 can be reduced by moving the motion sickness regulation image 22a as a background part around the gaze image 21a in the moving direction D2 that is the same as the direction D0 of the vection.

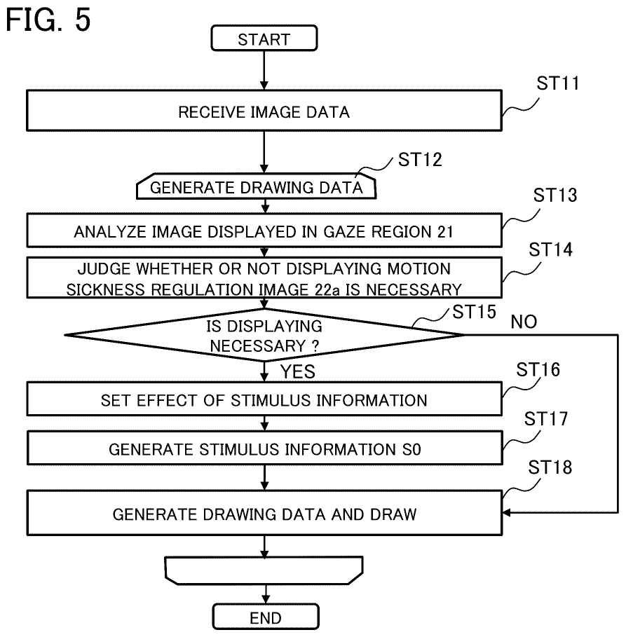

FIG. 5 is a flowchart showing the operation of the motion sickness regulation device 10 according to the first embodiment. First, the motion sickness regulation device 10 receiving the image data P0 (step ST11) executes playing back of the gaze image (referred to also as “fluid information”) 21a displayed in the gaze region 21 (step ST12). The motion sickness regulation device 10 analyzes the gaze image 21a (step ST13) and judges whether displaying the motion sickness regulation image 22a is necessary or not (step ST14). The necessity judgment is made based on, for example, information previously obtained by a test and indicating a relationship between the moving speed of the gaze image and the level of the motion sickness of the user viewing the gaze image.

When displaying the motion sickness regulation image is unnecessary (NO in step ST15), the motion sickness regulation device 10 generates drawing data without the motion sickness regulation image and outputs the drawing data to the display 20 (step ST18).

When displaying the motion sickness regulation image is necessary (YES in the step ST15), the motion sickness regulation device 10 sets the effect of the stimulus information (step ST16), generates the stimulus information by referring to the stimulus information DB (step ST17), generates drawing data including the motion sickness regulation image, and outputs the drawing data to the display 20 (step ST18). As a result, an image as a combination of the gaze image 21a and the motion sickness regulation image 22a like the image shown in FIG. 4 is displayed on the display 20, for example.

As described above, by using the motion sickness regulation device 10, the motion sickness regulation method or the motion sickness regulation program according to the first embodiment, the level of the motion sickness of the user 30 can be reduced by moving the motion sickness regulation image 22a as the background of the gaze image 21a in the moving direction D2 that is the same as the direction D0 of the vection (i.e., opposite to the moving direction D1 of the gaze image 21a).

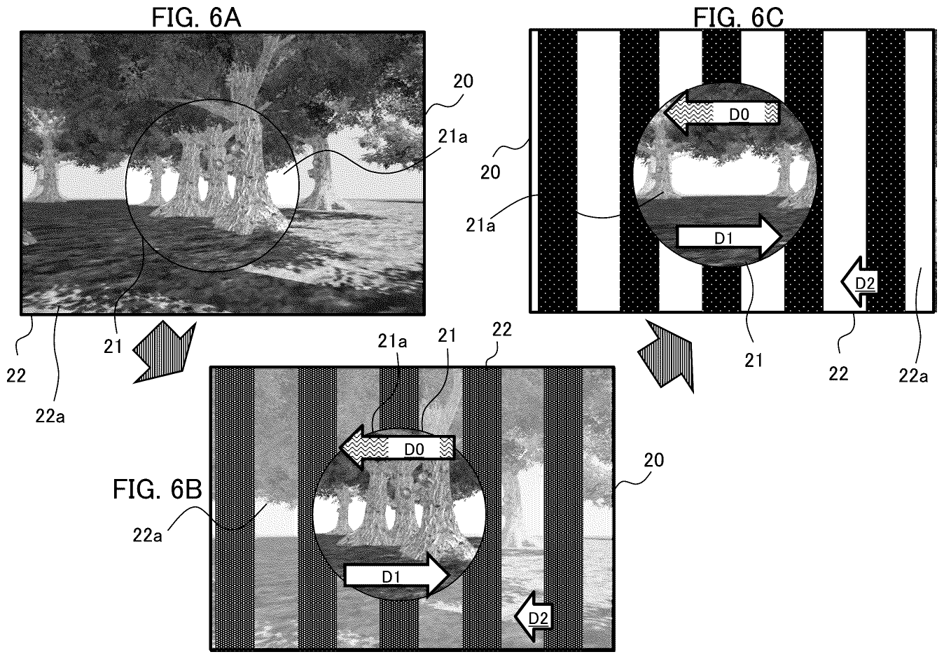

FIGS. 6A to 6C are diagrams showing a first example of a mode of emergence of the motion sickness regulation image 22a (i.e., an example of gradually changing transmittance of the motion sickness regulation image). FIG. 6A shows a state in which the transmittance of the motion sickness regulation image 22a is the highest (the transmittance is approximately 100%) and the motion sickness regulation image 22a is substantially invisible (the image based on the image data P0 is viewed). FIG. 6B shows a state in which the transmittance of the motion sickness regulation image 22a has decreased (the transmittance is approximately 50%) and both of a background image and the motion sickness regulation image 22a on the front side are visible. FIG. 6C shows a state in which the transmittance of the motion sickness regulation image 22a is approximately 0% and only the motion sickness regulation image 22a is visible.

As shown in FIGS. 6A to 6C, in the first example of the mode of emergence of the motion sickness regulation image 22a, the display control unit 12 at the start of displaying the motion sickness regulation image 22a gradually decreases the transmittance of the motion sickness regulation image 22a from a high value to a low value. Therefore, the emergence of the motion sickness regulation image 22a becomes less likely to be noticed by the user 30 and the attention of the user 30 is unlikely to be drawn to the motion sickness regulation image 22a. Further, if a mode of disappearance of the motion sickness regulation image 22a is performed in the order of FIG. 6C, FIG. 68 and FIG. 6A (i.e., in a process in the opposite order to the mode of emergence), the attention of the user 30 is unlikely to be drawn to the motion sickness regulation image 22a. The display control unit 12 may execute a process of changing the transmittance of the motion sickness regulation image at the end of displaying the motion sickness regulation image in addition to the process of changing the transmittance of the motion sickness regulation image at the start of displaying the motion sickness regulation image. Further, the display control unit 12 may execute the process of changing the transmittance of the motion sickness regulation image at the end of displaying the motion sickness regulation image instead of the process of changing the transmittance of the motion sickness regulation image at the start of displaying the motion sickness regulation image.

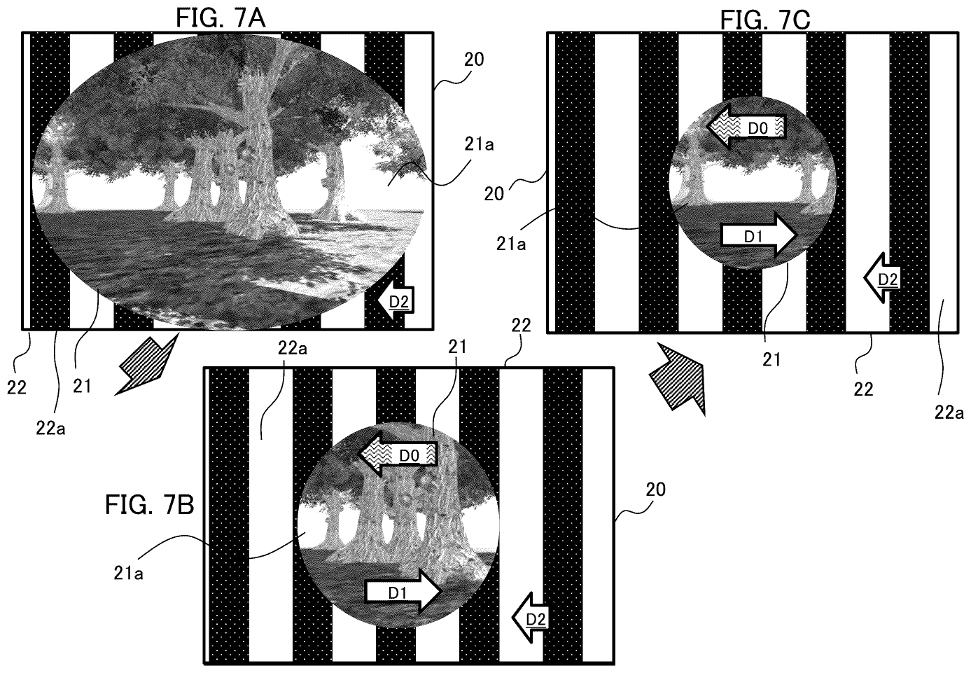

FIGS. 7A to 7C are diagrams showing a second example of the mode of emergence of the motion sickness regulation image 22a (i.e., an example of gradually changing the size of the gaze region 21). FIG. 7A shows a state in which the size of the gaze region 21 is large (i.e., the area of the motion sickness regulation region 22 is small). FIG. 78 shows a state in which the size of the gaze region 21 is approximately intermediate (i.e., the area of the motion sickness regulation region 22 is relatively large). FIG. 7C shows a state in which the size of the gaze region 21 is the smallest (i.e., the area of the motion sickness regulation region 22 is the largest).

As shown in FIGS. 7A to 7C, in the second example of the mode of emergence of the motion sickness regulation image 22a, the display control unit 12 at the start of displaying the motion sickness regulation image 22a gradually decreases the size of the gaze region 21 from a large value to a small value. Therefore, the emergence of the motion sickness regulation image 22a becomes less likely to be noticed by the user 30 and the attention of the user 30 is unlikely to be drawn to the motion sickness regulation image 22a. Further, if the mode of disappearance of the motion sickness regulation image 22a is performed in the order of FIG. 7C, FIG. 7B and FIG. 7A (i.e., in a process in the opposite order to the mode of emergence), the attention of the user 30 is unlikely to be drawn to the motion sickness regulation image 22a.

In other words, the display control unit 12 is capable of regulating the motion sickness occurrence effect by executing at least one of the process of gradually decreasing the size of the gaze region 21 from a large value to a small value at the start of displaying the motion sickness regulation image and the process of gradually increasing the size of the gaze region 21 from a small value to a large value at the end of displaying the motion sickness regulation image.

Further, the display control unit 12 is capable of regulating the motion sickness occurrence effect by executing at least one of a process of gradually increasing the size of the gaze region 21 from a small value to a large value at the start of displaying the motion sickness regulation image and a process of gradually decreasing the size of the gaze region 21 from a large value to a small value at the end of displaying the motion sickness regulation image.

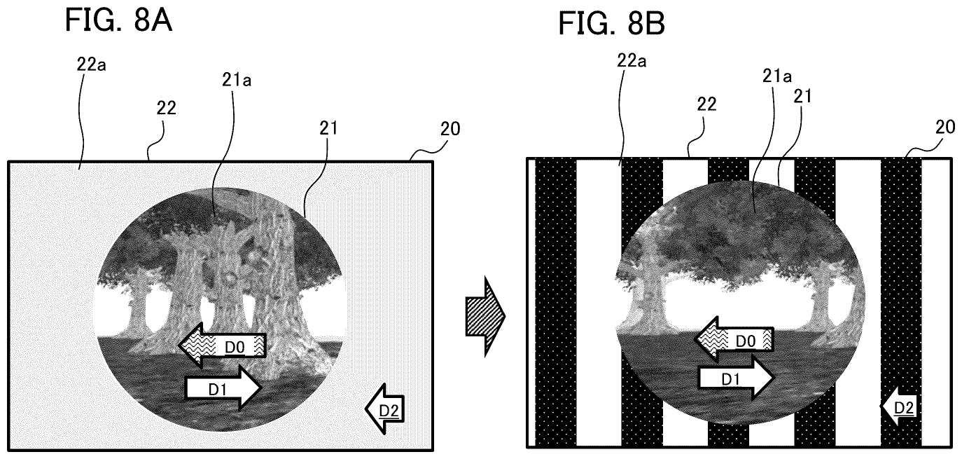

FIGS. 8A and 8B are diagrams showing a third example of the mode of emergence of the motion sickness regulation image 22a (i.e., an example of gradually changing the motion sickness regulation image 22a from a gray image to a stripe pattern image). FIG. 8A shows a state in which the motion sickness regulation region 22 is a unicolor image to which the attention of the user 30 is unlikely to be drawn (e.g., a gray image with low luminance or low density). FIG. 8B shows a state in which the luminance of the motion sickness regulation image 22a in the motion sickness regulation region 22 has increased or the density of the stripe pattern has gradually increased and finally the motion sickness regulation image 22a is displayed (i.e., the area of the motion sickness regulation region 22 is the largest).

As shown in FIGS. 8A and 8B, in the third example of the mode of emergence of the motion sickness regulation image 22a, the display control unit 12 at the start of displaying the motion sickness regulation image 22a first colors the motion sickness regulation image 22a with a single inconspicuous color, gradually increases the density, and finally lets the stripe pattern emerge. Therefore, the emergence of the motion sickness regulation image 22a becomes less likely to be noticed by the user 30 and the attention of the user 30 is unlikely to be drawn to the motion sickness regulation image 22a. Further, if the mode of disappearance of the motion sickness regulation image 22a is performed in the order of FIG. 8B and FIG. 8A (i.e., in a process in the opposite order to the mode of emergence), the attention of the user 30 is unlikely to be drawn to the motion sickness regulation image 22a.

In other words, the display control unit 12 is capable of reducing the motion sickness by executing at least one of the process of gradually increasing the luminance of the motion sickness regulation image from a low value to a high value at the start of displaying the motion sickness regulation image and the process of gradually decreasing the luminance of the motion sickness regulation image from a high value to a low value at the end of displaying the motion sickness regulation image. Further, the display control unit 12 is capable of enhancing the motion sickness occurrence effect by executing at least one of a process of gradually decreasing the luminance of the motion sickness regulation image from a high value to a low value at the start of displaying the motion sickness regulation image and a process of gradually increasing the luminance of the motion sickness regulation image from a low value to a high value at the end of displaying the motion sickness regulation image.

Alternatively, the display control unit 12 is capable of reducing the motion sickness by executing at least one of the process of gradually increasing the density of the motion sickness regulation image from a low value to a high value at the start of displaying the motion sickness regulation image and the process of gradually decreasing the density of the motion sickness regulation image from a high value to a low value at the end of displaying the motion sickness regulation image. Further, the display control unit 12 is capable of enhancing the motion sickness occurrence effect by executing at least one of a process of gradually decreasing the density of the motion sickness regulation image from a high value to a low value at the start of displaying the motion sickness regulation image and a process of gradually increasing the density of the motion sickness regulation image from a low value to a high value at the end of displaying the motion sickness regulation image.

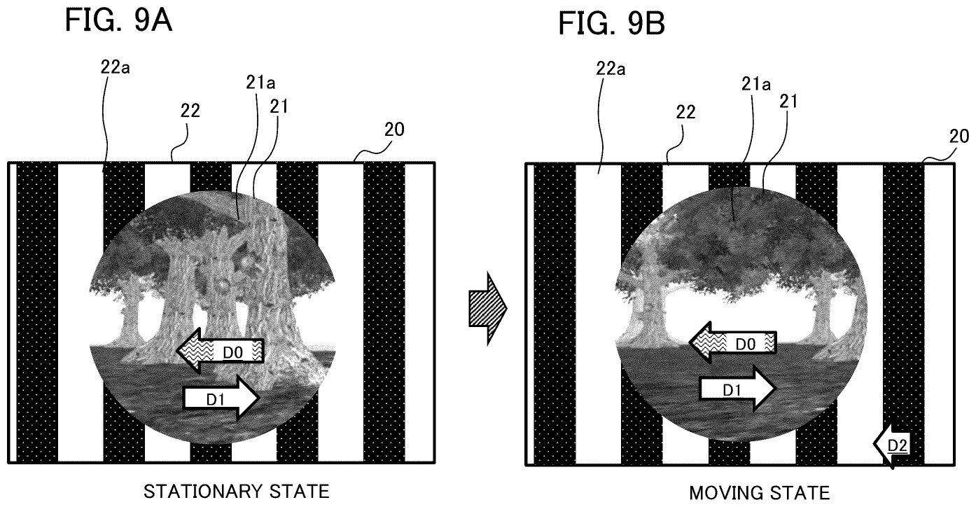

FIGS. 9A and 9B are diagrams showing a fourth example of the mode of emergence of the motion sickness regulation image (i.e., an example of gradually increasing the moving speed of the motion sickness regulation image from a stationary state). FIG. 9A shows a case where the motion sickness regulation image 22a is in the stationary state in which the attention of the user 30 is unlikely to be drawn to the motion sickness regulation image 22a. FIG. 9B shows a state in which the motion sickness regulation image 22a in the motion sickness regulation region 22 is moving in the moving direction D2.

As shown in FIGS. 9A and 9B, in the fourth example of the mode of emergence of the motion sickness regulation image 22a, the display control unit 12 at the start of displaying the motion sickness regulation image 22a first sets the motion sickness regulation image 22a in the stationary state, gradually increases the moving speed in the moving direction D2, and finally the moving speed reaches a speed specified by the stimulus information S0 generated by the stimulus information generation unit 11. Therefore, the start of the movement of the motion sickness regulation image 22a becomes less likely to be noticed by the user 30 and the attention of the user 30 is unlikely to be drawn to the motion sickness regulation image 22a. Further, if a mode of stopping the movement of the motion sickness regulation image 22a is performed in the order of FIG. 9B and FIG. 9A (i.e., in a process in the opposite order to the mode of starting the movement), the attention of the user 30 is unlikely to be drawn to the motion sickness regulation image 22a. In other words, the display control unit 12 is capable of reducing the motion sickness by executing at least one of the process of gradually increasing the moving speed of one or more objects at the start of displaying the motion sickness regulation image and the process of gradually decreasing the moving speed of one or more objects at the end of displaying the motion sickness regulation image.

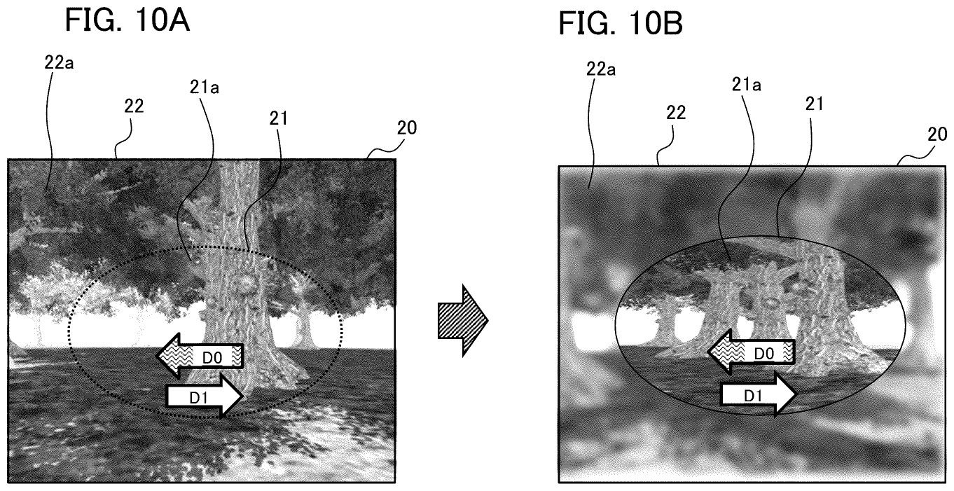

FIGS. 10A and 10B are diagrams showing a fifth example of the mode of emergence of the motion sickness regulation image 22a (i.e., an example of gradually increasing the blurring of the motion sickness regulation image 22a from a clear state). FIG. 10A shows a case where the motion sickness regulation image 22a is clear and in a state in which the attention of the user 30 is unlikely to be drawn to the motion sickness regulation image 22a. FIG. 10B shows a state in which the blurring has occurred to the motion sickness regulation image 22a in the motion sickness regulation region 22.

As shown in FIGS. 10A and 108, in the fifth example of the mode of emergence of the motion sickness regulation image 22a, the display control unit 12 at the start of displaying the motion sickness regulation image 22a first sets the motion sickness regulation image 22a in a clear and inconspicuous state, gradually increases the level of the blurring, and finally the blurring becomes blurring specified by the stimulus information S0 generated by the stimulus information generation unit 11. Therefore, the start of the emergence of the motion sickness regulation image 22a becomes less likely to be noticed by the user 30 and the attention of the user 30 is unlikely to be drawn to the motion sickness regulation image 22a. Further, if a mode of erasure of the motion sickness regulation image 22a is performed in the order of FIG. 108 and FIG. 10A (i.e., in a process in the opposite order to the mode of emergence), the attention of the user 30 is unlikely to be drawn to the motion sickness regulation image 22a.

In other words, the display control unit 12 is capable of regulating the motion sickness occurrence effect by executing at least one of the process of gradually increasing the level of the blurring of the motion sickness regulation image from a low value to a high value at the start of displaying the motion sickness regulation image and the process of gradually decreasing the level of the blurring of the motion sickness regulation image from a high value to a low value at the end of displaying the motion sickness regulation image.

Further, the display control unit 12 is capable of regulating the motion sickness occurrence effect by executing at least one of a process of gradually decreasing the level of the blurring of the motion sickness regulation image from a high value to a low value at the start of displaying the motion sickness regulation image and a process of gradually increasing the level of the blurring of the motion sickness regulation image from a low value to a high value at the end of displaying the motion sickness regulation image.

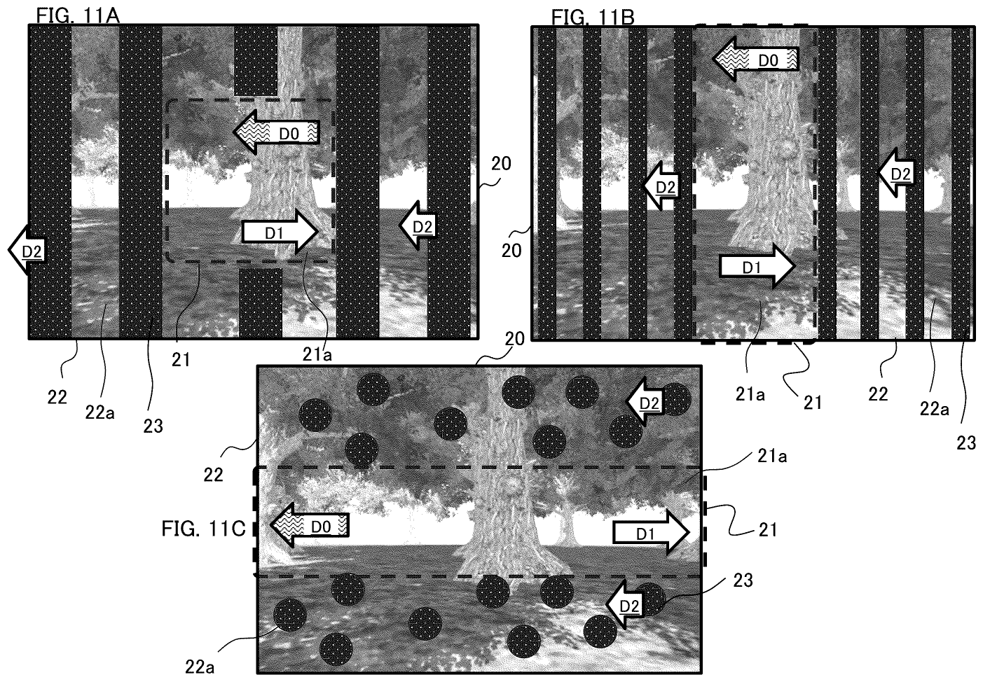

FIGS. 11A to 11C are diagrams showing another example of the image displayed on the display (an example in which the gaze region is in a quadrangular shape). FIG. 11A shows a case where the gaze region 21 exists at the center of the screen and the motion sickness regulation region 22 is formed at a position around and adjoining the gaze region 21. FIG. 11B shows a case where the gaze region 21 exists at the center of the screen in a horizontal direction and the motion sickness regulation region 22 is formed at positions around the gaze region 21 and adjoining the gaze region 21 leftward and rightward. FIG. 11C shows a case where the gaze region 21 exists at the center of the screen in a vertical direction and the motion sickness regulation region 22 is formed at positions around the gaze region 21 and adjoining the gaze region 21 upward and downward. Further, FIG. 11C shows an example in which the stimulus pattern forming the motion sickness regulation image 22a is a pattern of a plurality of moving circular dots. As shown in FIGS. 11A to 11C, the shape of the gaze region 21 can also be a quadrangular shape. Further, the shape of the gaze region 21 can also be a shape other than a circular shape, an elliptical shape or a quadrangular shape.

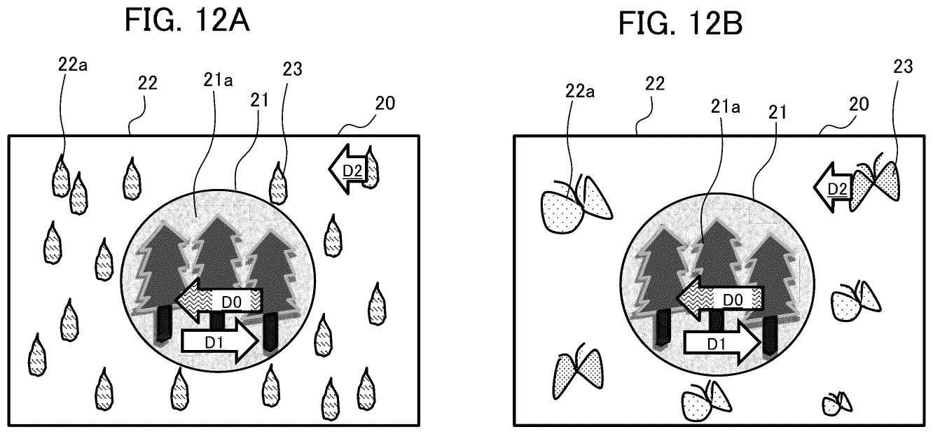

FIGS. 12A and 128 are diagrams showing other examples of the objects 23 (waterdrops and butterflies) forming the motion sickness regulation image 22a. As shown in the diagrams, the motion sickness regulation image 22a may be formed with a stimulus pattern using a plurality of waterdrops or a plurality of butterflies as the objects 23. As above, the object 23 forming the stimulus pattern is not limited to a geometrical shape but can also be a shape replicating the shape of a substance, an animal, a plant or the like existing in the natural world.

While the above description has been given of examples in which the moving direction D2 of the motion sickness regulation image 22a is the horizontal direction of the screen, the moving direction D2 is not limited to the horizontal direction. It is permissible if the moving direction D2 is determined depending on the moving direction D1 of the gaze image 21a.

### Second Embodiment

In the first embodiment, the description is given of the examples in which the gaze image 21a is displayed in the gaze region 21. In a second embodiment, a description will be given of examples in which the user 30 views a real moving gaze target (e.g., real scenery) in the gaze region 21.

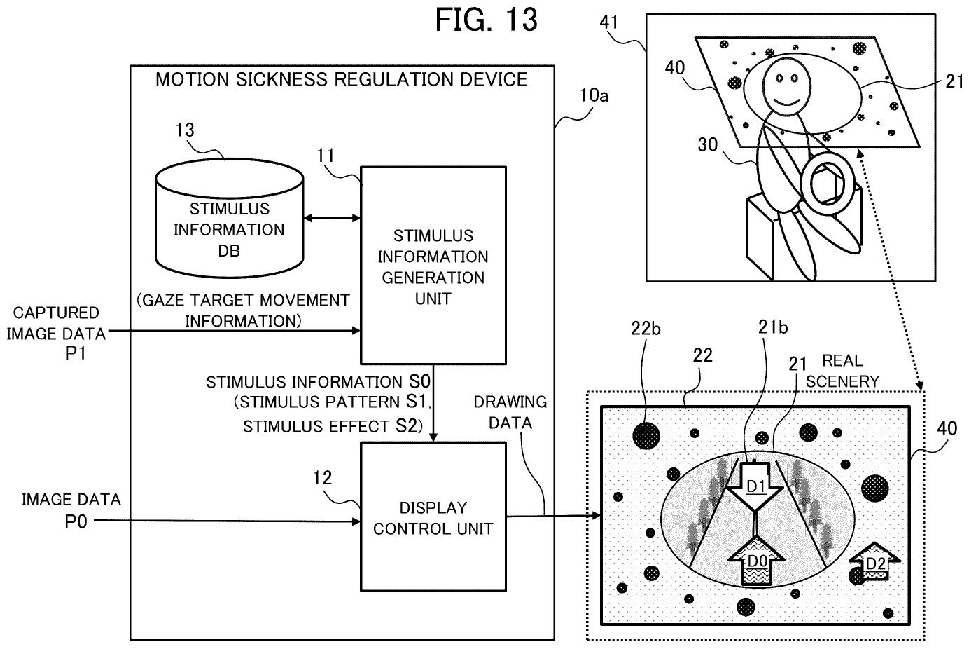

FIG. 13 is a diagram showing a configuration of a motion sickness regulation device 10a according to the second embodiment and an example of an image displayed on (i.e., projected onto) a windshield 40 of a vehicle 41. The motion sickness regulation device 10a is a device capable of executing a motion sickness regulation method according to the second embodiment. The motion sickness regulation device 10a is a computer, for example. The motion sickness regulation device 10a is capable of executing the motion sickness regulation method according to the second embodiment by executing a motion sickness regulation program. The motion sickness regulation device 10a is applicable also to AR glasses for viewing real scenery and an AR (Augmented Reality) image in superimposition with each other and the like. Further, the motion sickness regulation device 10a may display or project the motion sickness regulation image on/onto an in-vehicle display (e.g., a display on which a car navigation image is displayed, a rear display, a center display, or the like), an in-vehicle panel on which meters and the like are displayed, the hood of the vehicle, a pillar or the ceiling in the vehicle, or the like, instead of the windshield or in addition to the windshield. By expanding the display region of the motion sickness regulation image as above, the motion sickness of not only the driver but also a passenger other than the driver can be regulated effectively.

As shown in FIG. 13, the motion sickness regulation device 10a includes the stimulus information generation unit 11, the display control unit 12, and the stimulus information DB 13 previously stored in a storage device. The stimulus information DB 13 does not need to be a part of the motion sickness regulation device 10a but can be stored in an external storage device capable of communicating with the motion sickness regulation device 10a. The stimulus information generation unit 11 generates the stimulus information S0, to be used for making the display 20 display the motion sickness regulation image (i.e., stimulus image) 22a regulating the level of the motion sickness occurring to the user 30 viewing the gaze region 21, based on the movement of the gaze target in the gaze region 21 as the region in which the gaze image 21a as the image including the gaze target is displayed.

The display control unit 12 generates the motion sickness regulation image 22a based on the stimulus information S0 and has the motion sickness regulation image 22a displayed in the motion sickness regulation region 22 as a region on the display 20 adjoining the gaze region 21. In FIG. 13, the gaze image 21a includes scenery such as trees, and moves in the moving direction D1. In this case, the direction D0 of the vection is the direction opposite to the moving direction D1 of the scenery. Therefore, when the motion sickness occurs to the user 30 due to the movement of the scenery in the moving direction D1, the level of the motion sickness of the user 30 can be reduced by moving the motion sickness regulation image 22a including the stimulus pattern in the moving direction D2 that is the same as the direction D0 of the vection. Further, while the direction D0 of the vection and the moving direction D2 of the motion sickness regulation image 22a do not necessarily have to coincide with each other, it is desirable to make the directions coincide with each other.

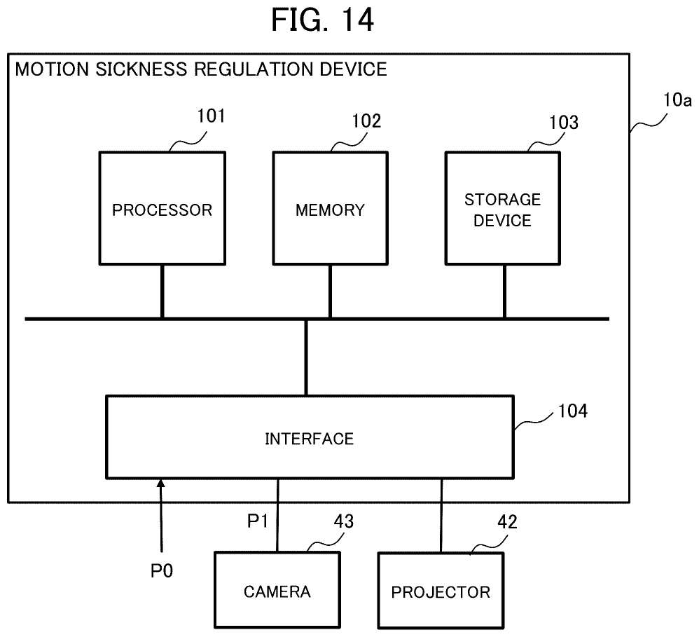

FIG. 14 is a diagram showing an example of a hardware configuration of the motion sickness regulation device 10a according to the second embodiment. In FIG. 14, each component identical or corresponding to a component shown in FIG. 2 is assigned the same reference character as in FIG. 2. The configuration in FIG. 14 differs from the configuration in FIG. 2 in including a camera 43 that captures images of the scene in front of the vehicle 41 and a projector 42. A camera image P1 captured by the camera 43 is supplied to the stimulus information generation unit 11, and the stimulus information generation unit 11 generates the stimulus information S0 based on the camera image P1. The projector 42 projects the stimulus pattern onto the windshield 40, for example.

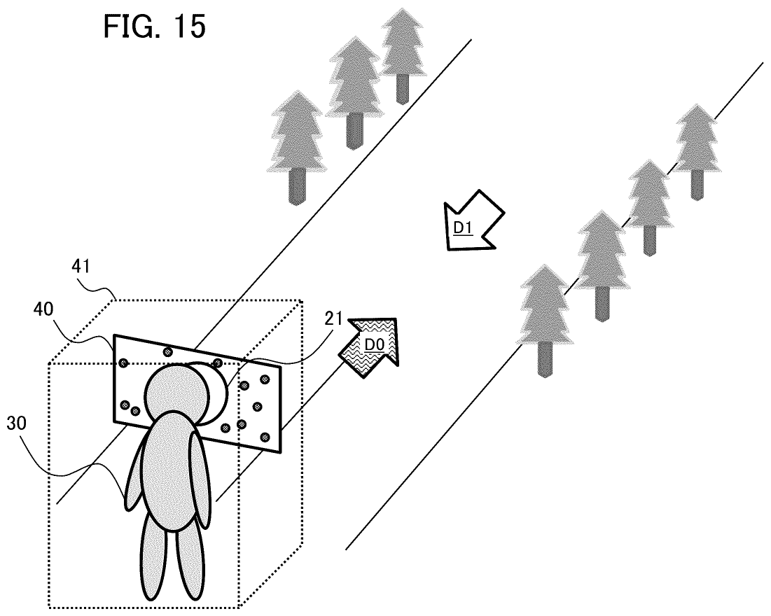

FIG. 15 is a diagram for explaining movement of the real scenery viewed through the windshield 40 shown in FIG. 13 and movement of the motion sickness regulation image displayed on the windshield. The gaze region 21 viewed through the windshield 40 shown in FIG. 13 corresponds to scenery when the user 30 with a display having an opening at its center placed in front of the user 30's face is advancing on a road. The direction D0 of the vection in this case is the direction opposite to the moving direction D1 of the scenery.

As described above, by using the motion sickness regulation device 10a, the motion sickness regulation method or the motion sickness regulation program according to the second embodiment, the level of the motion sickness of the user 30 can be reduced by moving the motion sickness regulation image 22a as the background of the gaze image 21a in the moving direction D2 that is the same as the direction D0 of the vection (i.e., opposite to the moving direction D1 of the gaze image 21a).

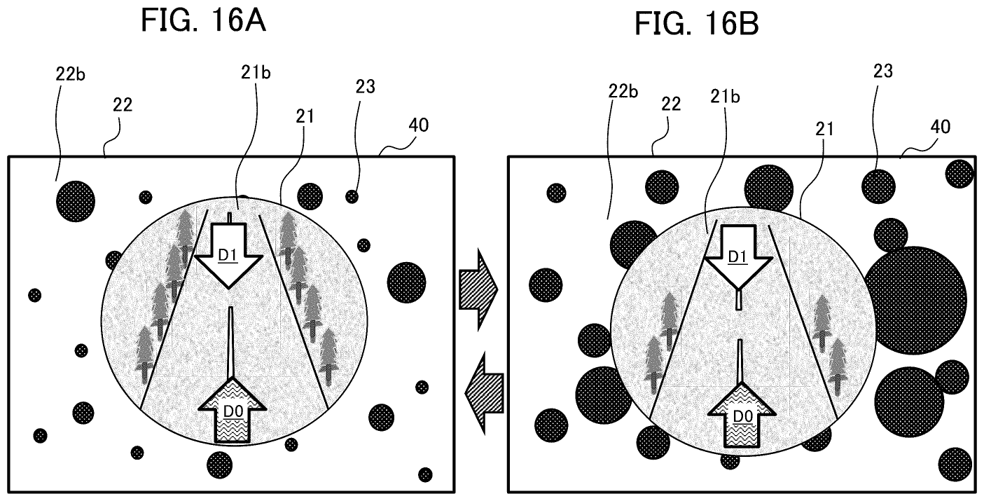

FIGS. 16A and 16B are diagrams showing another example of the movement (in the moving direction D1) of the real scenery viewed through the windshield 40 shown in FIG. 13 and the movement of a motion sickness regulation image 22b displayed on (e.g., projected onto) the windshield 40 (when the vehicle 41 is traveling forward). FIG. 16A shows the movement (in the moving direction D) of the real scenery viewed through the windshield 40 shown in FIG. 13 and circular objects 23 forming the stimulus pattern of the motion sickness regulation image 22b displayed on (e.g., projected onto) the windshield 40. FIG. 16B shows the movement (in the moving direction D1) of the real scenery viewed through the windshield 40 shown in FIG. 13 and large circular objects 23 forming the stimulus pattern of the motion sickness regulation image 22b displayed on (e.g., projected onto) the windshield 40.

As shown in FIGS. 16A and 16B, by using the motion sickness regulation device 10a, the motion sickness regulation method or the motion sickness regulation program according to the second embodiment, the level of the motion sickness of the user 30 can be reduced by changing the motion sickness regulation image 22b as the background of the gaze region 21 (i.e., changing the size of the objects 23) depending on the direction D0 of the vection. In other words, the display control unit 12 is capable of regulating the level of the motion sickness of the user 30 by executing at least one of the process of gradually increasing or decreasing the size of one or more objects at the start of displaying the motion sickness regulation image and the process of gradually decreasing or increasing the size of one or more objects at the end of displaying the motion sickness regulation image.

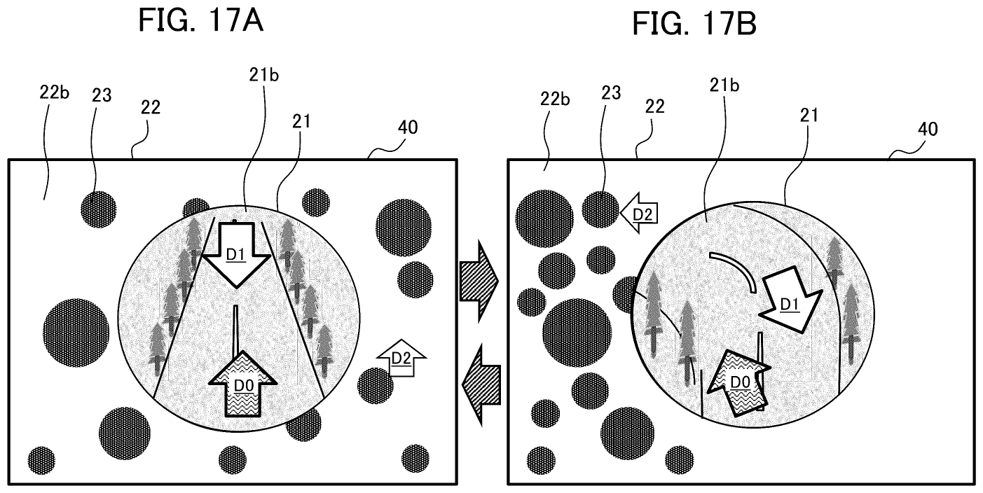

FIGS. 17A and 17B are diagrams showing another example of the movement of the real scenery viewed through the windshield 40 shown in FIG. 13 and the movement of the motion sickness regulation image displayed on the windshield 40 (when the vehicle 41 turns left). FIG. 17A shows the movement (in the moving direction D1) of the real scenery viewed through the windshield 40 shown in FIG. 13 and circular objects 23 forming the stimulus pattern of the motion sickness regulation image 22b displayed on (e.g., projected onto) the windshield 40. FIG. 17B shows the movement of the real scenery viewed through the windshield 40 shown in FIG. 13 (while the vehicle 41 is turning left) and circular objects 23 forming the stimulus pattern of the motion sickness regulation image 22b displayed on the windshield 40.

As shown in FIGS. 17A and 17B, by using the motion sickness regulation device 10a, the motion sickness regulation method or the motion sickness regulation program according to the second embodiment, the objects 23 are distributed in the whole region of the windshield 40 when the vehicle 41 is traveling straight, the objects 23 are concentrated on the left side of the windshield 40 when the vehicle 41 is turning left, and the objects 23 are concentrated on the right side of the windshield 40 when the vehicle 41 is turning right. By changing the arrangement of the objects 23 depending on the direction D0 of the vection as above, the level of the motion sickness of the user 30 can be reduced.

### Third Embodiment

In the first embodiment, the description is given of the example in which the motion sickness regulation image 22a is generated based on the gaze image 21a. In a third embodiment, a description will be given of examples in which the motion sickness regulation image 22a is generated by using the gaze image 21a and a motion sickness property of the user 30. Further, in the third embodiment, application for the purpose of enhancing the user 30's resistance to the motion sickness will also be described.

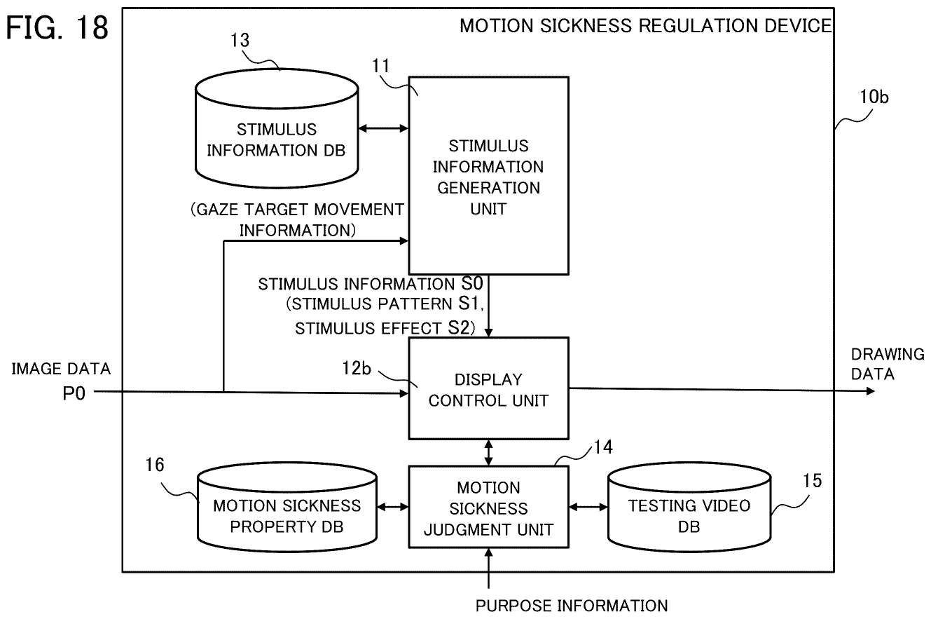

FIG. 18 is a diagram showing a configuration of a motion sickness regulation device 10b according to the third embodiment. The motion sickness regulation device 10b is a device capable of executing a motion sickness regulation method according to the third embodiment. The motion sickness regulation device 10b is a computer, for example. The motion sickness regulation device 10b is capable of executing the motion sickness regulation method according to the third embodiment by executing a motion sickness regulation program. The drawing data outputted from the motion sickness regulation device 10b is outputted to the display 20 similarly to the case in the first embodiment.

As shown in FIG. 18, the motion sickness regulation device 10b includes the stimulus information generation unit 11, a display control unit 12b, the stimulus information DB 13, a motion sickness judgment unit 14, a testing video DB 15, and an individual motion sickness property DB 16. The testing video DB 15 and the individual motion sickness property DB 16 do not need to be stored in a storage device as a part of the motion sickness regulation device 10b but can be stored in an external storage device capable of communicating with the motion sickness regulation device 10b.

The testing video DB 15 is a DB storing testing videos to be viewed by each user when the motion sickness property of each user (each individual) is judged. The motion sickness property DB 16 is a DB that stores each individual's motion sickness property judged when the user was made to view the testing videos.

The motion sickness judgment unit 14 executes a process of judging the motion sickness property of the user and storing the motion sickness property in the motion sickness property DB 16 and a process of providing, when a user is identified, the display control unit 12b with motion sickness property information on the relevant user. The motion sickness judgment by the motion sickness judgment unit 14 is made based on a result of measuring physical information on the user or the user's self-declaration (i.e., self-evaluation of the level of the motion sickness).

The display control unit 12b generates the motion sickness regulation image 22a based on the stimulus information S0 and the individual motion sickness property stored in the motion sickness property DB 16 and has the motion sickness regulation image (i.e., stimulus image) 22a displayed in the motion sickness regulation region 22.

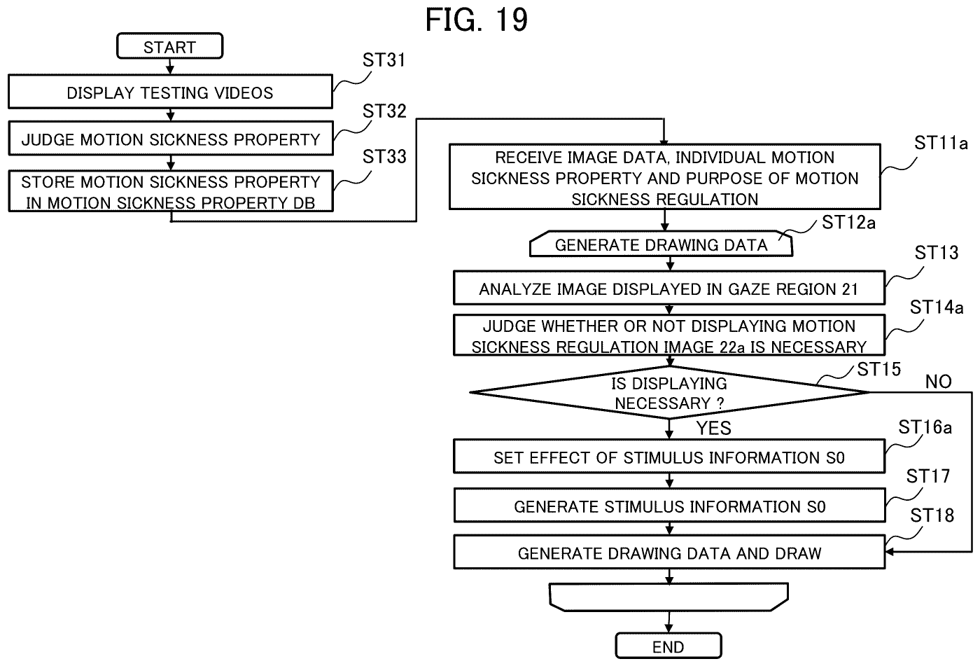

FIG. 19 is a flowchart showing an operation of the motion sickness regulation device 10b according to the third embodiment. The motion sickness regulation device 10b judges the motion sickness property of each individual by previously displaying the testing videos on the display (steps ST31 and ST32) and stores the motion sickness property in the motion sickness property DB 16 (step ST33).

When generating the drawing data, the motion sickness regulation device 10b receives the image data P0, the individual motion sickness property of the user and the purpose of the motion sickness regulation (step ST11a) and then performs playback of the gaze image (fluid information) displayed in the gaze region (step ST12a). The motion sickness regulation device 10b analyzes the gaze image displayed in the gaze region (step ST13) and judges whether displaying the motion sickness regulation image is necessary or not based on the result of the analysis, the individual motion sickness property and the purpose of the regulation (step ST14a).

When displaying the motion sickness regulation image is unnecessary (NO in step ST15), the motion sickness regulation device 10 generates the drawing data without the motion sickness regulation image and outputs the drawing data to the display 20 (step ST18).

When displaying the motion sickness regulation image is necessary (YES in the step ST15), the motion sickness regulation device 10b sets the effect of the stimulus information based on the result of the analysis, the individual motion sickness property and the purpose of the regulation (step ST16a), generates the stimulus information by referring to the stimulus information DB (step ST17), and generates the drawing data including the motion sickness regulation image and outputs the drawing data to the display 20 (step ST18).

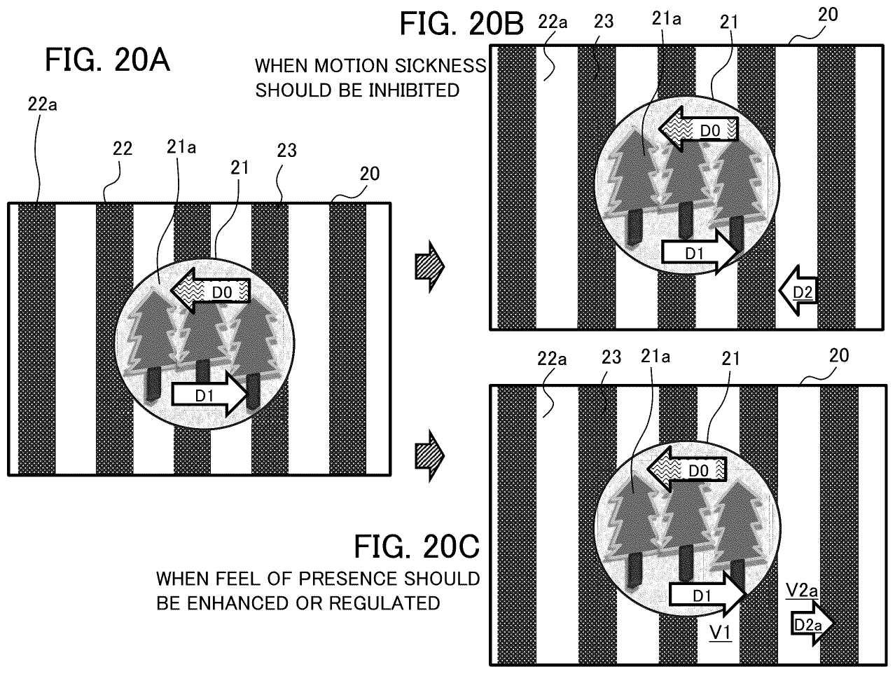

FIGS. 20A to 20C are diagrams showing an example of the image displayed on the display of the motion sickness regulation device 10b according to the third embodiment. FIG. 20A shows a state in which the motion sickness regulation image 22a is displayed in order to inhibit or promote the motion sickness caused by the gaze image 21a. FIG. 20B shows a situation in which a moving speed V2 of the motion sickness regulation image 22a is regulated in order to regulate the effect of inhibiting or promoting the motion sickness caused by the gaze image 21a when the moving direction D1 of the gaze image 21a is opposite to the moving direction D2 of the motion sickness regulation image 22a. FIG. 20C shows a situation in which the moving speed V2a of the motion sickness regulation image 22a is regulated in order to regulate the effect of inhibiting or promoting the motion sickness when the moving direction D1 of the gaze image 21a is the same as the moving direction D2a of the motion sickness regulation image 22a.

In FIG. 20C, when the motion sickness is not caused by the movement of the gaze image 21a alone, an effect of promoting the motion sickness (i.e., an effect of enhancing the feel of presence) is obtained if the motion sickness regulation image 22a is displayed together with the gaze image 21a and the speed V2a of the motion sickness regulation image 22a is set higher than the speed V1 of the gaze image 21a (i.e., V2a>V1). Further, in FIG. 20C, when the motion sickness is caused by the movement of the gaze image 21a alone, an effect of diminishing the occurrence of the motion sickness (i.e., an effect of regulating the feel of presence) is obtained if the motion sickness regulation image 22a is displayed together with the gaze image 21a and the speed V2a of the motion sickness regulation image 22a is set lower than the speed V1 of the gaze image 21a (i.e., V2a<V1). Since the device employing the effects shown in FIGS. 20A to 20C is capable of regulating the effect of inhibiting or promoting the motion sickness, the device is useful for training for enhancing the user 30's resistance to the motion sickness.

As described above, by using the motion sickness regulation device 10b, the motion sickness regulation method or the motion sickness regulation program according to the third embodiment, the level of the motion sickness of the user 30 can be reduced by moving the background of the gaze image in the moving direction D2 that is the same as the direction D0 of the vection.

Further, when the purpose is enhancing the user's resistance to the motion sickness, the level of the motion sickness of the user 30 can be increased by moving the background of the gaze image in the direction D2a opposite to the direction D0 of the vection.

### DESCRIPTION OF REFERENCE CHARACTERS

10, 10a, 10b: motion sickness regulation device, 11: stimulus information generation unit, 12, 12a: display control unit, 13: stimulus information DB, 20: display, 21: gaze region, 21a: gaze image, 21b: real gaze target, 22: motion sickness regulation region, 22a, 22b: motion sickness regulation image (stimulus image), 23: object, 30: user, 40: windshield, 41: vehicle, D0: direction of self-kinesthetic sensation (vection), D1: moving direction of gaze target, D2: moving direction of motion sickness regulation image, S0: stimulus information.

What is claimed is:

1. A motion sickness regulation device comprising:
processing circuitry
to generate stimulus information to be used for displaying a motion sickness regulation image for regulating a level of motion sickness occurring to a user viewing a gaze region, as a region in which real scenery is visible or a region in which a gaze image as an image including a gaze target is displayed, based on movement of the scenery or the gaze image in the gaze region; and
to generate the motion sickness regulation image based on the stimulus information, to specify a motion sickness regulation region as a region as part or a whole of a region excluding the gaze region, and to have the motion sickness regulation image displayed in the motion sickness regulation region.

2. The motion sickness regulation device according to claim 1, wherein the motion sickness regulation image includes a stimulus pattern made up of moving one or more objects.

3. The motion sickness regulation device according to claim 2, wherein a moving direction of the one or more objects is a direction opposite to a moving direction of the scenery or the gaze image in the gaze region.

4. The motion sickness regulation device according to claim 2, wherein
a moving direction of the one or more objects is a same direction as a moving direction of the scenery or the gaze image in the gaze region, and
a moving speed of the one or more objects is equal to or lower than a moving speed of the scenery or the gaze image in the gaze region.

5. The motion sickness regulation device according to claim 2, wherein the stimulus pattern includes a plurality of regularly arranged objects or a plurality of randomly arranged objects.

6. The motion sickness regulation device according to claim 5, wherein the plurality of regularly arranged objects are a plurality of regularly arranged stripes.

7. The motion sickness regulation device according to claim 5, wherein the plurality of randomly arranged objects include one or more object sets among an object set made up of a plurality of dots, an object set made up of a plurality of figures and an object set made up of a plurality of creatures.

8. The motion sickness regulation device according to claim 1, wherein the processing circuitry executes at least one of a process of changing transmittance of the motion sickness regulation image at a start of displaying the motion sickness regulation image and a process of changing the transmittance of the motion sickness regulation image at an end of displaying the motion sickness regulation image.

9. The motion sickness regulation device according to claim 1, wherein the processing circuitry executes at least one of a process of gradually increasing luminance of the motion sickness regulation image from a low value to a high value at a start of displaying the motion sickness regulation image and a process of gradually decreasing the luminance of the motion sickness regulation image from a high value to a low value at an end of displaying the motion sickness regulation image.

10. The motion sickness regulation device according to claim 1, wherein the processing circuitry executes at least one of a process of gradually decreasing luminance of the motion sickness regulation image from a high value to a low value at a start of displaying the motion sickness regulation image and a process of gradually increasing the luminance of the motion sickness regulation image from a low value to a high value at an end of displaying the motion sickness regulation image.

11. The motion sickness regulation device according to claim 1, wherein the processing circuitry executes at least one of a process of gradually increasing color density of the motion sickness regulation image from a low value to a high value at a start of displaying the motion sickness regulation image and a process of gradually decreasing the color density of the motion sickness regulation image from a high value to a low value at an end of displaying the motion sickness regulation image.

12. The motion sickness regulation device according to claim 1, wherein the processing circuitry executes at least one of a process of gradually decreasing color density of the motion sickness regulation image from a high value to a low value at a start of displaying the motion sickness regulation image and a process of gradually increasing the color density of the motion sickness regulation image from a low value to a high value at an end of displaying the motion sickness regulation image.

13. The motion sickness regulation device according to claim 2, wherein the processing circuitry executes at least one of a process of gradually increasing or decreasing a size of the one or more objects at a start of displaying the motion sickness regulation image and a process of gradually decreasing or increasing the size of the one or more objects at an end of displaying the motion sickness regulation image.

14. The motion sickness regulation device according to claim 2, wherein the processing circuitry executes at least one of a process of gradually decreasing a size of the gaze region from a large value to a small value at a start of displaying the motion sickness regulation image and a process of gradually increasing the size of the gaze region from a small value to a large value at an end of displaying the motion sickness regulation image.

15. The motion sickness regulation device according to claim 2, wherein the processing circuitry executes at least one of a process of gradually increasing a size of the gaze region from a small value to a large value at a start of displaying the motion sickness regulation image and a process of gradually decreasing the size of the gaze region from a large value to a small value at an end of displaying the motion sickness regulation image.

16. The motion sickness regulation device according to claim 2, wherein the processing circuitry executes at least one of a process of gradually increasing a moving speed of the one or more objects at a start of displaying the motion sickness regulation image and a process of gradually decreasing the moving speed of the one or more objects at an end of displaying the motion sickness regulation image.

17. The motion sickness regulation device according to claim 2, wherein the processing circuitry executes at least one of a process of gradually increasing a level of blurring of the motion sickness regulation image from a low value to a high value at a start of displaying the motion sickness regulation image and a process of gradually decreasing the level of the blurring of the motion sickness regulation image from a high value to a low value at an end of displaying the motion sickness regulation image.

18. The motion sickness regulation device according to claim 2, wherein the processing circuitry executes at least one of a process of gradually decreasing a level of blurring of the motion sickness regulation image from a high value to a low value at a start of displaying the motion sickness regulation image and a process of gradually increasing the level of the blurring of the motion sickness regulation image from a low value to a high value at an end of displaying the motion sickness regulation image.

19. The motion sickness regulation device according to claim 1, wherein the motion sickness regulation region is a region around the gaze region and adjoining the gaze region, regions respectively adjoining the gaze region upward and downward, regions respectively adjoining the gaze region leftward and rightward, or a region arranged with spacing from the gaze region.

20. The motion sickness regulation device according to claim 1, wherein the processing circuitry acquires information regarding the movement of the scenery or the gaze image in the gaze region from a camera image obtained by photographing a region including the gaze target.

21. The motion sickness regulation device according to claim 1, wherein the processing circuitry judges whether the motion sickness regulation image is necessary or not based on the movement of the scenery or the gaze image in the gaze region.

22. The motion sickness regulation device according to claim 1, wherein the processing circuitry judges whether the motion sickness regulation image is necessary or not based on the movement of the scenery or the gaze image in the gaze region and motion sickness likelihood property information previously collected in regard to the user.

23. The motion sickness regulation device according to claim 1, wherein the processing circuitry switches the motion sickness regulation image depending on whether inputted purpose information indicates reduction of the motion sickness or enhancement of resistance to the motion sickness.

24. A motion sickness regulation method executed by a motion sickness regulation device, the method comprising:
generating stimulus information to be used for displaying a motion sickness regulation image for regulating a level of motion sickness occurring to a user viewing a gaze region, as a region in which real scenery is visible or a region in which a gaze image as an image including a gaze target is displayed, based on movement of the scenery or the gaze image in the gaze region; and
generating the motion sickness regulation image based on the stimulus information, specifying a motion sickness regulation region as a region as part or a whole of a region excluding the gaze region, and having the motion sickness regulation image displayed in the motion sickness regulation region.

25. A non-transitory computer-readable storage medium for storing a motion sickness regulation program that causes a computer to execute processing comprising:
generating stimulus information to be used for displaying a motion sickness regulation image for regulating a level of motion sickness occurring to a user viewing a gaze region, as a region in which real scenery is visible or a region in which a gaze image as an image including a gaze target is displayed, based on movement of the scenery or the gaze image in the gaze region; and
generating the motion sickness regulation image based on the stimulus information, specifying a motion sickness regulation region as a region as part or a whole of a region excluding the gaze region, and having the motion sickness regulation image displayed in the motion sickness regulation region.
